(19) United States
(12) Patent Application Publication
(10) Pub. No.: US 2014/0033520 A1
(43) Pub. Date: Feb. 6, 2014

(54) CRIMPING JIG

(71) Applicant: YAZAKI CORPORATION, TOKYO (JP)

(72) Inventor: Takumi NAKAGISHI, Makinohara-shi (JP)

(73) Assignee: YAZAKI CORPORATION, TOKYO (JP)

(21) Appl. No.: 13/953,801

(22) Filed: Jul. 30, 2013

(30) Foreign Application Priority Data
Aug. 2, 2012 (JP) 2012-171671

(51) Int. Cl. H01R 43/048

(52) U.S. Cl. CPC H01R 43/048
USPC 29/753

(57) ABSTRACT

A crimping jig includes a pair of mold members configured to hold a conductor of an electric wire and a conductor crimping portion of a crimping terminal between the pair of mold members to crimp the conductor crimping portion onto the conductor. The pair of mold members includes a crimping portion configured to crimp a pair of crimping pieces of the conductor crimping portion onto the conductor, a first preventing portion provided on the crimping portion towards an edge of the conductor and configured to prevent a deformation of the pair of crimping pieces in a length direction of the electric wire, and a second preventing portion provided on the crimping portion toward a derivation portion of the conductor and configured to prevent a deformation of the pair of crimping pieces in the length direction of the electric wire.

### CROSS REFERENCE TO RELATED APPLICATION

This application is based upon and claims the benefit of priority from the prior Japanese Patent Application No. 2012-171671, filed on Aug. 2, 2012, the entire contents of which are incorporated herein by reference.

### BACKGROUND

1. Technical Field

The present invention relates to a crimping jig used for crimping a crimping terminal onto a conductor.

2. Related Art

Japanese Unexamined Patent Application Publication No. 2009-193879 proposes a crimping terminal crimped onto the conductor of an electric wire with a crimping jig. The crimping terminal includes a conductor crimping portion having a bottom plate and a pair of conductor crimping pieces provided at both sides of the bottom plate, and is provided with openings configured to absorb the longitudinal metallic extension of the bottom plate due to the pressure applied at the crimping at both sides of the conductor crimping portion in the longitudinal direction of the bottom plate.

A crimping jig configured to crimp a conductor crimping portion of a crimping terminal onto the conductor of an electric wire as described above includes a pair of mold members having an upper mold and a lower mold so that the pair of mold members holds the conductor crimping portion and the conductor therebetween in order to stretch the conductor crimping portion and the conductor in a longitudinal direction, break the oxide films formed on both of the conductor crimping portion and the conductor, and expose their newly-formed surfaces, so that the conductor crimping portion and the conductor are attached to each other.

### SUMMARY

However, the crimping jig as described in Japanese Unexamined Patent Application Publication No. 2009-193879 stretches the conductor crimping portion of the crimping terminal in the length direction of the electric wire similarly to the conductor of the electric wire. Thus, when the conductor is an aluminum electric wire, it is difficult to increase the area in which the conductor crimping portion and the conductor are attached to each other. Further, when the conductor is a copper electric wire, it is difficult to increase the area in which the newly-formed surfaces of the conductor crimping portion and the conductor contact with each other.

An objective of the present invention is to provide a crimping jig capable of increasing the area in which the conductor crimping portion and the conductor are attached to each other and the area in which the newly-formed surfaces of the conductor crimping portion and the conductor contact with each other.

A crimping jig in accordance with some embodiments includes a pair of mold members configured to hold a conductor of an electric wire and a conductor crimping portion of a crimping terminal between the pair of mold members to crimp the conductor crimping portion onto the conductor. The pair of mold members includes a crimping portion configured to crimp a pair of crimping pieces of the conductor crimping portion onto the conductor, a first preventing portion provided on the crimping portion towards an edge of the conductor and configured to prevent a deformation of the pair of crimping pieces in a length direction of the electric wire, and a second preventing portion provided on the crimping portion toward a derivation portion of the conductor and configured to prevent a deformation of the pair of crimping pieces in the length direction of the electric wire.

According to the above-mentioned structure, the first preventing portion and the second preventing portion can prevent the deformation of the pair of crimping pieces of the conductor crimping portion in the length direction of the electric wire. This can cause the amounts of deformation of the conductor crimping portion and the conductor of the electric wire in the length direction of the electric wire to differ from each other. This can increase the area in which the conductor crimping portion and the conductor are attached to each other when the conductor is an aluminum electric wire and can increase the area in which the newly-formed surfaces of the conductor crimping portion and the conductor contact with each other when the conductor is a copper electric wire.

Thus, the crimping jig prevents the conductor crimping portion from deforming similarly to the conductor with the first preventing portion and the second preventing portion and can increase the area in which the conductor crimping portion and the conductor are attached to each other and the area in which the newly-formed surfaces of the conductor crimping portion and the conductor contact with each other.

The first preventing portion and the second preventing portion may include protrusions protruding toward a direction across the length direction of the electric wire.

According to the above-mentioned structure, the first preventing portion and the second preventing portion include protrusions protruding toward the direction across the length direction of the electric wire. This can cause the amounts of deformation of the conductor crimping portion and the conductor in the length direction of the electric wire to differ from each other with a simple structure.

The protrusions of the first preventing portion and the second preventing portion may contact with both sides of the pair of crimping pieces in the length direction of the electric wire. The protrusion of the first preventing portion may have an edge surface configured to press a bottom plate of the conductor crimping portion. The protrusions of the second preventing portion may have an edge surface configured to press the conductor.

According to the above-mentioned structure, the protrusions of the first preventing portion and the second preventing portion contact with both sides of the pair of crimping pieces in the length direction of the electric wire so that an edge surface of the protrusion of the first preventing portion presses a bottom plate of the conductor crimping portion, and an edge surface of the protrusion of the second preventing portion presses the conductor. This can facilitate the deformation of the conductor toward the derivation portion while surely preventing the deformation of the pair of crimping pieces. This can cause the amounts of deformation of the conductor crimping portion and the conductor in the length direction of the electric wire to drastically differ from each other.

The protrusions of the first preventing portion and the second preventing portion may be engaged with recesses provided on the pair of crimping pieces.

According to the above-mentioned structure, the protrusions of the first preventing portion and the second preventing portion are engaged with recesses provided on the pair of crimping pieces. This can prevent the misalignment of the pair of mold members and the conductor crimping portion while preventing the deformation of the pair of crimping pieces. Thus, the conductor crimping portion can stably be crimped onto the conductor.

The above-mentioned structure can provide a crimping jig capable of increasing the area in which the conductor crimping portion and the conductor are attached to each other and the area in which the newly-formed surfaces of the conductor crimping portion and the conductor contact with each other.

### BRIEF DESCRIPTION OF DRAWINGS

FIG. 1 is a perspective view of a crimping jig according to a first embodiment of the present invention;

FIG. 2 is a perspective view of FIG. 1 viewed from below;

FIG. 3 is a top view of the crimping jig according to the first embodiment of the present invention;

FIG. 4 is a cross-sectional view taken along line IV-IV of FIG. 3;

FIG. 5 is an enlarged cross-sectional view of the crimping jig according to the first embodiment of the present invention;

FIG. 6 is a perspective view of a crimping jig according to a second embodiment of the present invention;

FIG. 7 is a side view of the crimping jig according to the second embodiment of the present invention;

FIG. 8 is a top view of the crimping jig according to the second embodiment of the present invention;

FIG. 9A is a cross-sectional view taken along line IXa-IXa of FIG. 7, and FIG. 9B is an enlarged view of FIG. 9A;

FIG. 10A is a cross-sectional view taken along line Xa-Xa of FIG. 8, and FIG. 10B is an enlarged view of FIG. 10A;

FIG. 11 is an enlarged cross-sectional view of the crimping jig according to the second embodiment of the present invention; and

FIG. 12 is an enlarged cross-sectional view of the pair of mold members of an exemplary related art.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

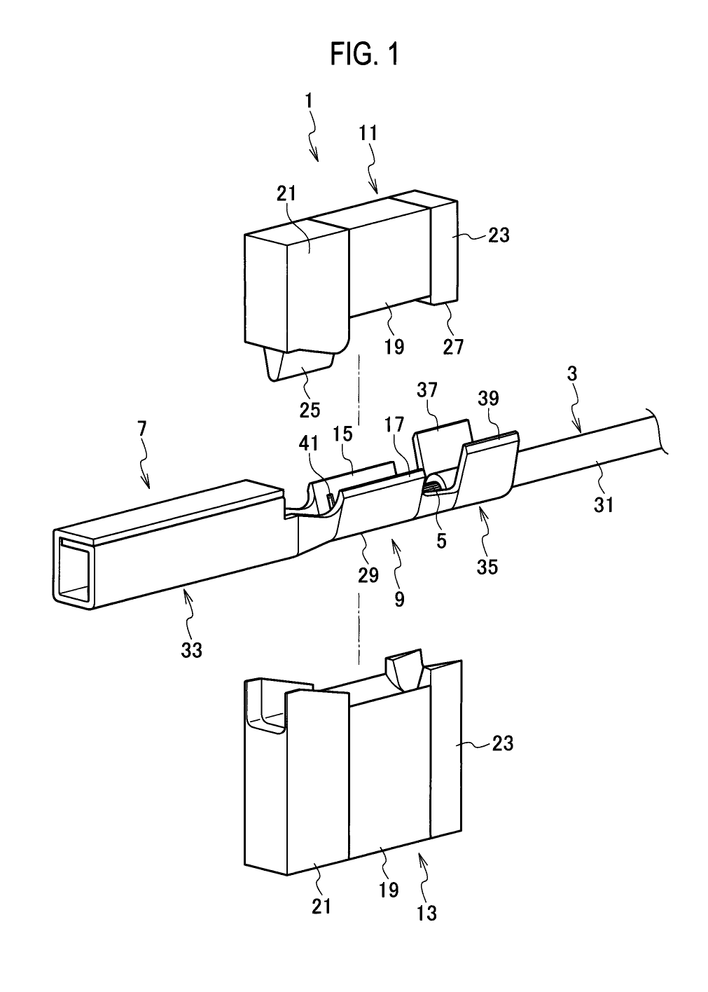

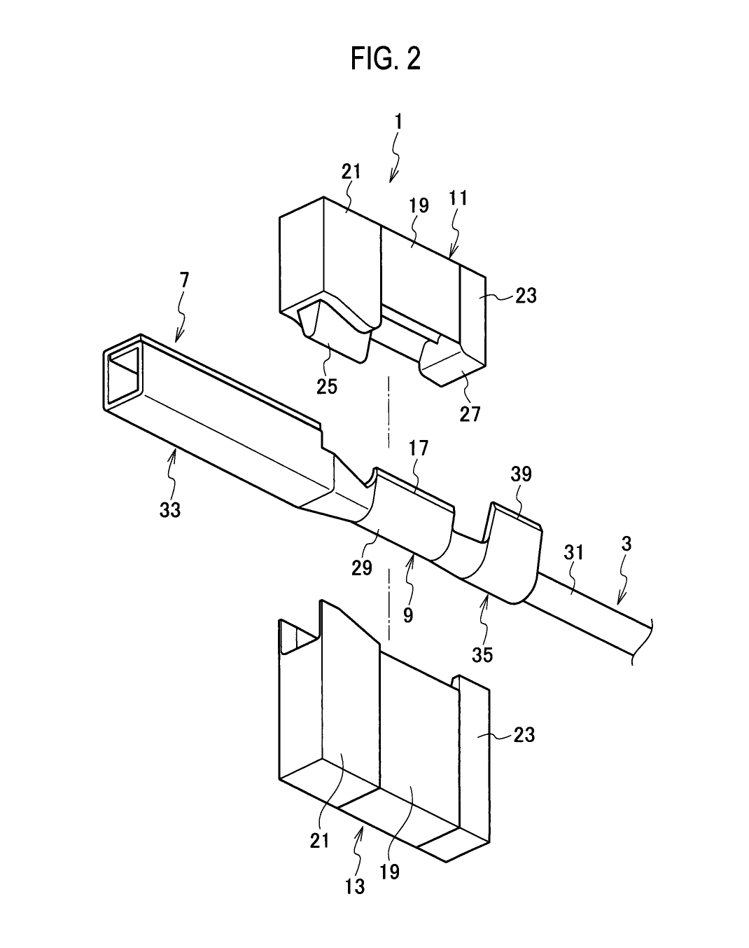

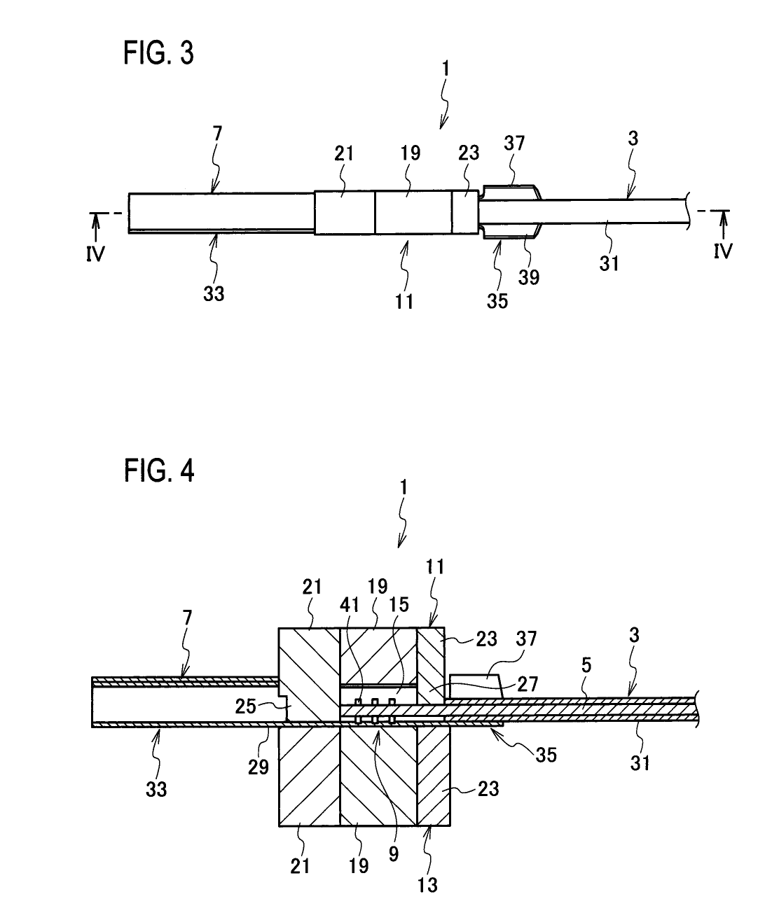

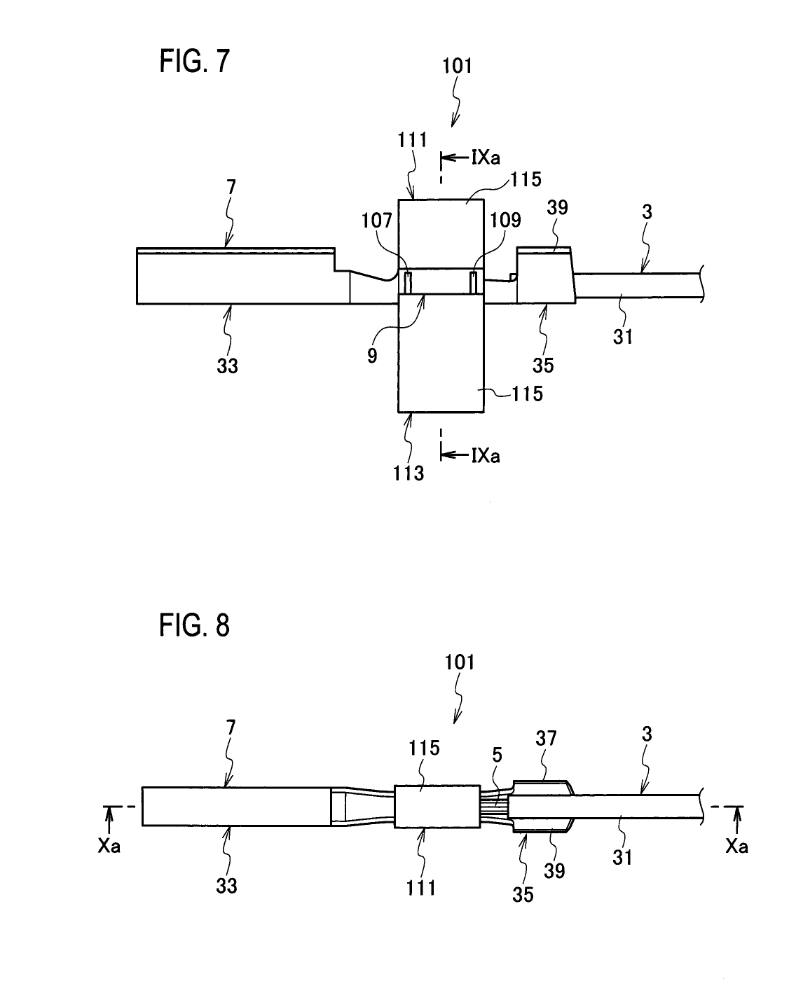

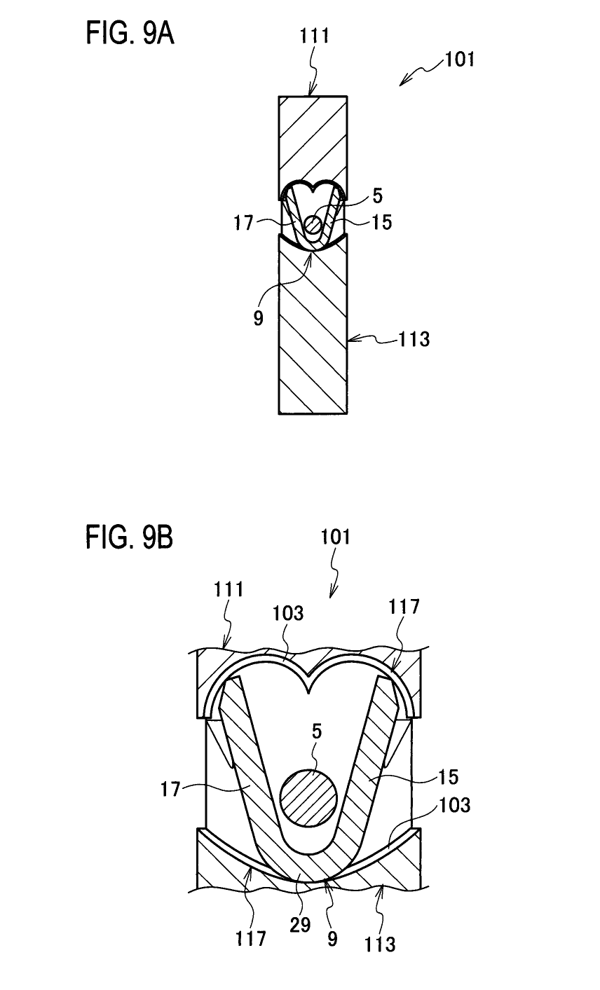

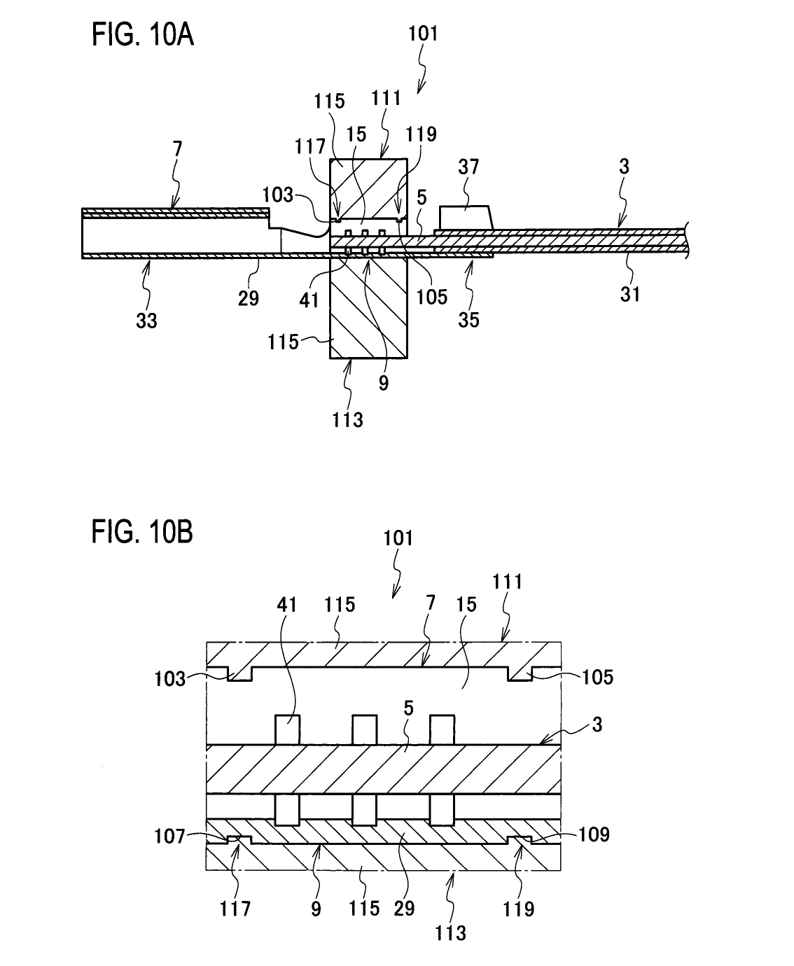

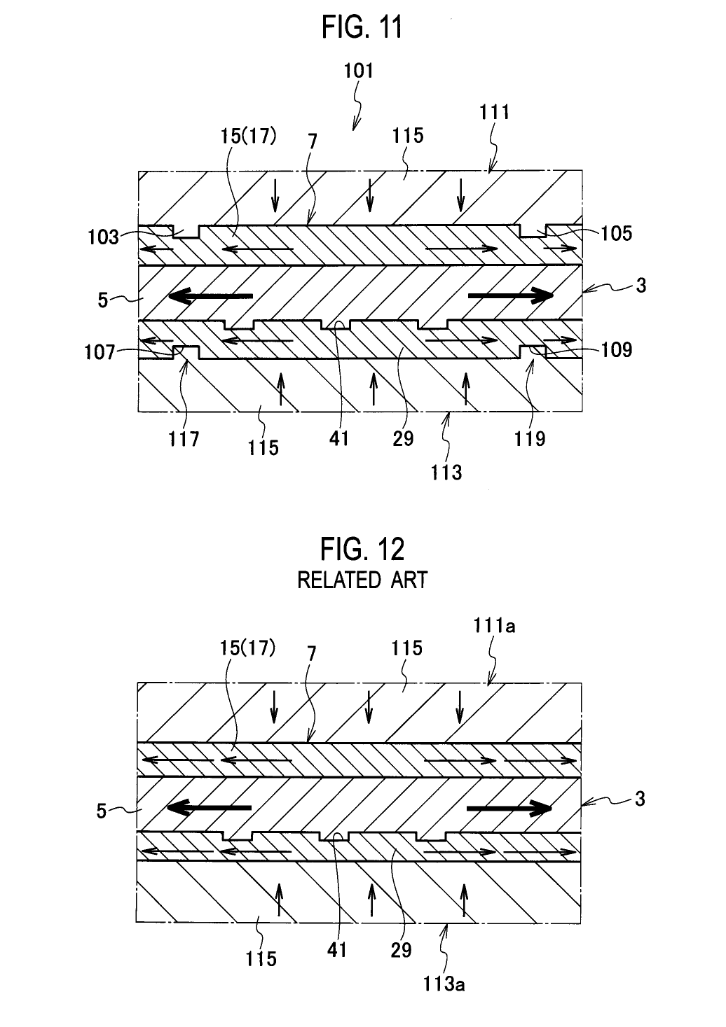

Crimping jigs according to the embodiments of the present invention will be described with reference to FIGS. 1 to 11. FIG. 12 illustrates an exemplary related art.

### First Embodiment

A first embodiment will be described with reference to FIGS. 1 to 5.

A crimping jig 1 according to the present embodiment includes a pair of mold members 11 and 13 configured to hold a conductor 5 of an electric wire 3 and a conductor crimping portion 9 of a crimping terminal 7 therebetween in order to crimp the conductor crimping portion 9 onto the conductor 5.

The pair of mold members 11 and 13 includes crimping portions 19 configured to crimp a pair of crimping pieces 15 and 17 of the conductor crimping portion 9 onto the conductor 5, first preventing portions 21 provided at a side of the crimping portions 19 that is placed on the edge side of the conductor 5 and configured to prevent the pair of crimping pieces 15 and 17 from deforming in the length direction of the electric wire 3, and second preventing portions 23 provided at the other side of the crimping portions 19 that is placed toward the derivation portion of the conductor 5 and configured to prevent the pair of crimping pieces 15 and 17 from deforming in the length direction of the electric wire 3.

The first preventing portions 21 and the second preventing portions 23 include protrusions 25 and 27 protruding toward the direction across the length direction of the electric wire 3 (downward in FIG. 1).

The protrusions 25 and 27 contact with both sides of the pair of crimping pieces 15 and 17 in the length direction of the electric wire 3 such that an edge surface of the protrusion 25 of the first preventing portions 21 presses a bottom plate 29 of the conductor crimping portion 9 and an edge surface of the protrusion 27 of the second preventing portions 23 presses the conductor 5.

As illustrated in FIGS. 1 to 5, the electric wire 3 includes the conductor 5 including a plurality of stranded wires and an insulating sheath 31 covering the conductor 5. For example, the stranded wires are composed of aluminum metal including aluminum or aluminum alloys, or copper metal including copper or copper alloys. A predetermined length of the insulating sheath 31 is peeled from the edge of the electric wire 3 in order to crimp the crimping terminal 7 onto the exposed conductor 5.

The crimping terminal 7 is composed of copper metal including copper or copper alloys and includes an electricity connecting portion 33, a sheath crimping portion 35, and the conductor crimping portion 9. A tin coat is applied to the surface of the crimping terminal 7. The electricity connecting portion 33 is a female mold formed into a box shape having a junction therein. An electricity connecting portion of the counterpart terminal (not illustrated) that is a male mold having a tab shape is inserted into the electricity connecting portion 33 such that the crimping terminal 7 is electrically connected to the counterpart terminal. The electricity connecting portion 33 is formed into a member that is connected to the sheath crimping portion 35 and the conductor crimping portion 9 through the bottom plate 29.

The sheath crimping portion 35 is provided on the longitudinal opposite side of the electricity connecting portion 33 across the conductor crimping portion 9, and includes a pair of crimping pieces 37 and 39 that are vertically provided as a portion connected to both sides of the bottom plate 29. The pair of crimping pieces 37 and 39 are crimped in such a way as to surround the outer periphery of the insulating sheath 31 of the electric wire 3 in order to fix the crimping terminal 7 and the electric wire 3. The conductor crimping portion 9 is formed as a continuous portion through the bottom plate 29 between the sheath crimping portion 35 and the electricity connecting portion 33.

The conductor crimping portion 9 includes the pair of crimping pieces 15 and 17 that are vertically provided as a portion connected to the conductor crimping portion 9 and longitudinally provided between the electricity connecting portion 33 and the sheath crimping portion 35. The pair of crimping pieces 15 and 17 is crimped in such a way as to surround the outer periphery of the conductor 5 of the electric wire 3, and is crimped onto the conductor 5 in order to cause the crimping terminal 7 and the electric wire 3 to conduct electricity.

A plurality of (herein, three) serrations 41 is provided at the bottom plate 29 and the pair of crimping pieces 15 and 17 of the conductor crimping portion 9 in a direction orthogonal to the longitudinal direction. The serrations 41 break an oxide film formed on the surface of the conductor 5 of the electric wire 3 when the conductor crimping portion 9 is crimped onto the conductor 5 of the electric wire 3 in order to attach the conductor crimping portion 9 to the conductor 5 (intermetallic bond between Sn and Al) when the electric wire 3 is an aluminum electric wire and in order to contact newly-formed surfaces of the conductor 5 and the conductor crimping portion 9 with each other when the electric wire 3 is a copper electric wire.

The conductor 5 of the electric wire 3 and the conductor crimping portion 9 of the crimping terminal 7 are crimped with the crimping jig 1. The crimping jig 1 includes the pair of mold members 11 and 13 configured to hold the conductor 5 of the electric wire 3 and the conductor crimping portion 9 of the crimping terminal 7 therebetween in order to crimp the conductor crimping portion 9 onto the conductor 5. The pair of mold members 11 and 13 includes the crimping portions 19, the first preventing portions 21, and the second preventing portions 23.

The crimping portions 19 are oppositely placed as holding the pair of crimping pieces 15 and 17 therebetween. A curved surface formed into an M shape is provided on the crimping portion 19 of an upper mold member 11 in order to fold the pair of crimping pieces 15 and 17 such that the edges of the crimping pieces 15 and 17 butt each other when the pair of mold members 11 and 13 holds the conductor 5 and the conductor crimping portion 9 therebetween such that the conductor crimping portion 9 is crimped onto the conductor 5.

On the other hand, a curved surface formed into a semicircular shape is provided on the crimping portion 19 of a lower mold member 13 in order to press and fold the bottom plate 29 when the pair of mold members 11 and 13 holds the conductor 5 and the conductor crimping portion 9 therebetween such that the conductor crimping portion 9 is crimped onto the conductor 5. The first preventing portions 21 are integrally provided on the electricity connecting portion 33 side of the crimping portions 19.

The first preventing portions 21 are oppositely placed as holding a connection of the electricity connecting portion 33 and the pair of crimping pieces 15 and 17 therebetween. A protrusion 25 is provided on a first preventing portion 21 of the upper mold member 11 as protruding toward a first preventing portion 21 of the lower mold member 13.

Note that the first preventing portions 21 are formed into a shape such that the parts except for the protrusion 25 does not press the crimping terminal 7 but surrounds the periphery of the crimping terminal 7 when the pair of mold members 11 and 13 holds the conductor 5 and the conductor crimping portion 9 therebetween such that the conductor crimping portion 9 is crimped onto the conductor 5.

The edge surface of the protrusion 25 presses the bottom plate 29 of the conductor crimping portion 9 so that the side on the conductor 5 side of the protrusion 25 contacts with the sides of the crimping pieces 15 and 17 when the pair of mold members 11 and 13 holds the conductor 5 and the conductor crimping portion 9 such that the conductor crimping portion 9 is crimped onto the conductor 5.

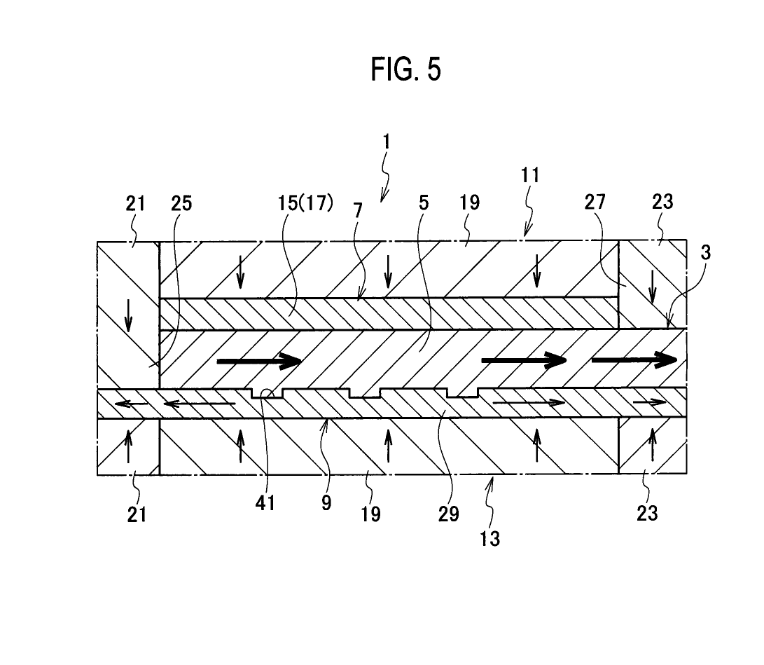

As illustrated with the arrows in FIG. 5, the side of the protrusion 25 prevents the conductor 5 and the pair of crimping pieces 15 and 17 from deforming toward the electricity connecting portion 33 side in the length direction of the electric wire 3 and the edge surface of the protrusion 25 causes only the bottom plate 29 to deform toward the electricity connecting portion 33 side in the length direction of the electric wire 3 when the conductor crimping portion 9 is crimped onto the conductor 5. Note that, in FIG. 5, the arrows of the pair of mold members 11 and 13 show the direction of the pressure and the arrows of the conductor 5 and the conductor crimping portion 9 show the direction of deformation and the amount of deformation. The second preventing portions 23 are integrally provided with the crimping portions 19 on the opposite side to the first preventing portions 21 across the crimping portions 19.

The second preventing portions 23 are oppositely placed as holding a connection of the pair of crimping pieces 15 and 17 and the pair of crimping pieces 37 and 39 therebetween. A protrusion 27 is provided on a second preventing portion 23 of the upper mold member 11 as protruding toward a second preventing portion 23 of the lower mold member 13.

Note that the second preventing portion 23 of the lower mold member 13 of the pair of mold members 11 and 13 is formed into a recess in order to house the protrusion 27 and the connection of the pair of crimping pieces 15 and 17 and the pair of crimping pieces 37 and 39 therein when the pair of mold members 11 and 13 holds the conductor 5 and the conductor crimping portion 9 therebetween such that the conductor crimping portion 9 is crimped onto the conductor 5.

The edge surface of the protrusion 27 presses the conductor 5 of the electric wire 3 between the pair of crimping pieces 15 and 17 and the pair of crimping pieces 37 and 39 so that the side on the crimping pieces 15 and 17 side of the protrusion 27 contacts with the sides of the crimping pieces 15 and 17 when the pair of mold members 11 and 13 holds the conductor 5 and the conductor crimping portion 9 therebetween such that the conductor crimping portion 9 is crimped onto the conductor 5.

The protrusion 27 prevents the pair of crimping pieces 15 and 17 from deforming toward the derivation portion (towards the pair of crimping pieces 37 and 39 side) in the length direction of the electric wire 3 and the edge surface of the protrusion 27 causes the conductor 5 and the bottom plate 29 to deform toward the derivation portion in the length direction of the electric wire 3 when the conductor crimping portion 9 is crimped onto the conductor 5.

The crimping jig 1 including the above-mentioned structure holds the conductor 5 of the electric wire 3 and the conductor crimping portion 9 of the crimping terminal 7 with the pair of mold members 11 and 13, so that the crimping portions 19 crimps the pair of crimping pieces 15 and 17 in order to crimp the pair of crimping pieces 15 and 17 onto the conductor 5.

Then, the first preventing portions 21 prevents the conductor 5 and the pair of crimping pieces 15 and 17 from deforming toward the electricity connecting portion 33 side with the side of the protrusion 25 while pressing the bottom plate 29 with the edge of the protrusion 25. Meanwhile, the second preventing portions 23 prevent the pair of crimping pieces 15 and 17 from deforming toward the derivation portion with the side of the protrusion 27 while pressing the conductor 5 and the bottom plate 29 with the edge surface of the protrusion 27.

The first preventing portions 21 and, the second preventing portions 23 prevent the pair of crimping pieces 15 and 17 from deforming in the length direction of the electric wire 3 and deform the conductor 5 toward the derivation portion. As described above, preventing the deformation of the conductor crimping portion 9 and increasing the deformation of the conductor 5 do not cause the conductor crimping portion 9 to deform similarly to the conductor 5. This facilitates breaking the oxide film formed on the surface of the conductor 5 with the serrations 41 of the conductor crimping portion 9.

This can increase the area in which the conductor crimping portion 9 and the conductor 5 are attached to each other when the conductor 5 is an aluminum electric wire and can increase the area in which the newly-formed surfaces of the conductor crimping portion 9 and the conductor 5 contact with each other when the conductor 5 is a copper electric wire.

The crimping jig 1 can prevent the pair of crimping pieces 15 and 17 of the conductor crimping portion 9 from deforming in the length direction of the electric wire 3 with the first preventing portions 21 and the second preventing portions 23. This can cause the amounts of deformation of the conductor crimping portion 9 and the conductor 5 of the electric wire 3 in the length direction of the electric wire 3 to differ from each other. This can efficiently increase the area in which the conductor crimping portion 9 and the conductor 5 are attached to each other when the conductor 5 is an aluminum electric wire and the area in which the newly-formed surfaces of the conductor crimping portion 9 and the conductor 5 contact with each other when the conductor 5 is a copper electric wire.

Thus, the crimping jig 1 can increase the area in which the conductor crimping portion 9 and the conductor 5 are attached to each other and the area in which the newly-formed surfaces of the conductor crimping portion 9 and the conductor 5 contact with each other because the first preventing portions 21 and the second preventing portions 23 prevent the conductor crimping portion 9 from deforming similarly to the conductor 5.

Further, the first preventing portions 21 and the second preventing portions 23 include the protrusions 25 and 27 protruding in the direction across the length direction of the electric wire 3. This can cause the amounts of deformation of the conductor crimping portion 9 and the conductor 5 in the length direction of the electric wire 3 to differ from each other with a simple structure.

Further, the protrusions 25 and 27 of the first preventing portions 21 and the second preventing portions 23 contact with both sides of the pair of crimping pieces 15 and 17 in the length direction of the electric wire 3 so that the edge surface of the protrusion 25 of the first preventing portions 21 presses the bottom plate 29 of the conductor crimping portion 9 and the edge surface of the protrusion 27 of the second preventing portions 23 presses the conductor 5. This can facilitate the deformation of the conductor 5 toward the derivation portion while surely preventing the deformation of the pair of crimping pieces 15 and 17. Thus, this can cause the amounts of deformation of the conductor crimping portion 9 and the conductor 5 in the length direction of the electric wire 3 to drastically differ from each other.

### Second Embodiment

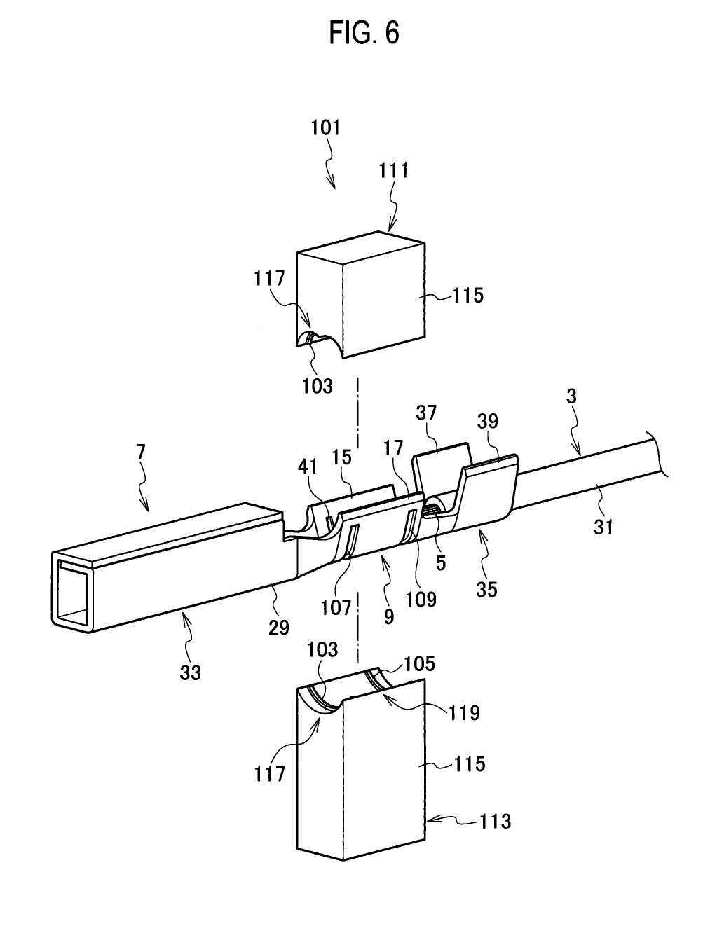

A second embodiment will be described with reference to FIGS. 6 to 11.

A crimping jig 101 according to the present embodiment includes protrusions 103 and 105 that are engaged with recesses 107 and 109 provided on a pair of crimping pieces 15 and 17.

Note that the same components as in the first embodiment are denoted with the same reference signs and the descriptions for the components and the functions are omitted with reference to the descriptions in the first embodiment. The same effects as the first embodiment are obtained with the components in the second embodiment because the components are the same as the first embodiment.

As illustrated in FIGS. 6 to 11, the crimping jig 101 includes a pair of mold members 111 and 113 configured to hold a conductor 5 of an electric wire 3 and a conductor crimping portion 9 of a crimping terminal 7 therebetween in order to crimp the conductor crimping portion 9 onto the conductor 5. The pair of mold members 111 and 113 includes crimping portions 115, first preventing portions 117, and second preventing portions 119.

The crimping portions 115 are oppositely placed as holding the pair of crimping pieces 15 and 17 therebetween. A curved surface formed into an M shape is provided on the crimping portion 115 of an upper mold member 111 in order to fold the pair of crimping pieces 15 and 17 such that the edges of the crimping pieces 15 and 17 butt each other when the pair of mold members 111 and 113 holds the conductor 5 and the conductor crimping portion 9 therebetween such that the conductor crimping portion 9 is crimped onto the conductor 5.

On the other hand, a curved surface formed into a semicircular shape is provided on the crimping portion 115 of a lower mold member 113 in order to press and fold a bottom plate 29 when the pair of mold members 111 and 113 holds the conductor 5 and the conductor crimping portion 9 therebetween such that the conductor crimping portion 9 is crimped onto the conductor 5. The first preventing portions 117 are integrally provided on the electricity connecting portion 33 side of the crimping portion 115. The second preventing portions 119 are integrally provided toward the derivation portion (toward the pair of crimping pieces 37 and 39).

The first preventing portions 117 and the second preventing portions 119 are oppositely placed on longitudinal both sides of the pair of crimping pieces 15 and 17, respectively. The first preventing portions 117 and the second preventing portions 119 are formed along the thickness direction of the pair of mold members 111 and 113 (the direction orthogonal to the length direction of the electric wire 3) and include the protrusions 103 and 105 protruding toward the pair of mold members 111 and 113, respectively.

The protrusions 103 and 105 are engaged with the recesses 107 and 109 formed on the pair of the crimping pieces 15 and 17 when the pair of mold members 111 and 113 hold the conductor 5 and the conductor crimping portion 9 therebetween such that the conductor crimping portion 9 is crimped onto the conductor 5. The engagement of the protrusions 103 and 105 with the recesses 107 and 109 can prevent the misalignment of the pair of mold members 111 and 113 and the conductor crimping portion 9 when the conductor crimping portion 9 is crimped onto the conductor 5.

Meanwhile, the engagement of the protrusions 103 and 105 with the recesses 107 and 109 prevents the deformation of the pair of crimping pieces 15 and 17 and the bottom plate 29 in the length direction of the electric wire 3 as illustrated with the arrows in FIG. 11. Note that, in FIG. 11, the arrows of the pair of mold members 111 and 113 show the direction of the pressure and the arrows of the conductor 5 and the conductor crimping portion 9 show the direction of deformation and the amount of deformation.

On the contrary, the exemplary related art illustrated in FIG. 12 crimps a conductor crimping portion 9 onto the conductor 5 with a pair of mold members 111a and 113a that are not provided with protrusions 103 and 105. Thus, a pair of crimping pieces 15 and 17 and a bottom plate 29 deform in the length direction of an electric wire 3, similarly to the conductor 5. Thus, it is difficult to efficiently break an oxide film formed on the surface of the conductor 5 with a serration 41 of conductor crimping portion 9.

The first preventing portions 117 and the second preventing portions 119 prevent the deformation of the pair of crimping pieces 15 and 17 and the bottom plate 29 in the length direction of the electric wire 3 when the conductor crimping portion 9 is crimped onto the conductor 5 and facilitates the deformation of the conductor 5 in the length direction of the electric wire 3. As described above, preventing the deformation of the conductor crimping portion 9 and increasing the deformation of the conductor 5 do not cause the conductor crimping portion 9 to deform similarly to the conductor 5. This facilitates breaking the oxide film formed on the surface of the conductor 5 with the serrations 41 of the conductor crimping portion 9.

This can increase the area in which the conductor crimping portion 9 and the conductor 5 are attached to each other when the conductor 5 is an aluminum electric wire and the area in which the newly-formed surfaces of the conductor crimping portion 9 and the conductor 5 contact with each other when the conductor is a copper electric wire.

In the crimping jig 101, the protrusions 103 and 105 of the first preventing portions 117 and the second preventing portions 119 are engaged with the recesses 107 and 109 formed on the pair of crimping pieces 15 and 17. This can prevent the misalignment of the pair of mold members 111 and 113 and the conductor crimping portion 9 while preventing the deformation of the pair of crimping pieces 15 and 17. Thus, the conductor crimping portion 9 can stably be crimped onto the conductor 5.

Note that the crimping jig according to the second embodiment of the present invention includes the protrusions continuously formed along the curved surface of the crimping portion. However, the invention is not limited to the embodiment. The crimping jig can also include a plurality of protrusions formed along the curved surface of the crimping portion.

Although the embodiments of the present invention has been described above, the invention is not limited to the above embodiment, and various modifications are possible.

What is claimed is:

1. A crimping jig comprising:
a pair of mold members configured to hold a conductor of an electric wire and a conductor crimping portion of a crimping terminal between the pair of mold members to crimp the conductor crimping portion onto the conductor,
wherein the pair of mold members includes
a crimping portion configured to crimp a pair of crimping pieces of the conductor crimping portion onto the conductor,
a first preventing portion provided on the crimping portion towards an edge of the conductor and configured to prevent a deformation of the pair of crimping pieces in a length direction of the electric wire, and
a second preventing portion provided on the crimping portion toward a derivation portion of the conductor and configured to prevent a deformation of the pair of crimping pieces in the length direction of the electric wire.

2. The crimping jig according to claim 1, wherein the first preventing portion and the second preventing portion include protrusions protruding toward a direction across the length direction of the electric wire.

3. The crimping jig according to claim 2,
wherein the protrusions of the first preventing portion and the second preventing portion contact with both sides of the pair of crimping pieces in the length direction of the electric wire,
wherein the protrusion of the first preventing portion has an edge surface configured to press a bottom plate of the conductor crimping portion, and
wherein the protrusions of the second preventing portion has an edge surface configured to press the conductor.

4. The crimping jig according to claim 2, wherein the protrusions of the first preventing portion and the second preventing portion are engaged with recesses provided on the pair of crimping pieces.
